(19) United States
(12) Patent Application Publication
(10) Pub. No.: US 2021/0142444 A1
(43) Pub. Date: May 13, 2021

(54) MAP DATA SOURCE PROCESSING METHOD, MAP UPDATING METHOD, DEVICE, AND STORAGE MEDIUM

(71) Applicant: SZ DJI TECHNOLOGY CO., LTD., Shenzhen (CN)

(72) Inventors: Bo WU, Shenzhen (CN); Ang LIU, Shenzhen (CN); Litian ZHANG, Shenzhen (CN)

(21) Appl. No.: 17/154,887

(22) Filed: Jan. 21, 2021

Related U.S. Application Data
(63) Continuation of application No. PCT/CN2018/097760, filed on Jul. 31, 2018.

(51) Int. Cl. G06T 3/40; G06K 9/46; G06T 7/50

(52) U.S. Cl. CPC G06T 3/40; G06T 7/50; G06K 9/46

(57) ABSTRACT

A map data source processing method includes determining a target pixel for an expansion operation from a map data source, determining an expansion parameter for the expansion operation on the target pixel, and performing the expansion operation on the target pixel based on the expansion parameter.

### CROSS-REFERENCE TO RELATED APPLICATION

This application is a continuation of International Application No. PCT/CN2018/097760, filed on Jul. 31, 2018, the entire content of which is incorporated herein by reference.

### TECHNICAL FIELD

The present disclosure relates to the field of map technology and, more particularly, to a map data source processing method, a map updating method, a device, and a storage medium.

### BACKGROUND

For movable devices such as unmanned aerial vehicles (UAVs), robots, and unmanned automobiles, map support is required for autonomous navigation. For example, a map can be used to plan a driving path. The map describes obstacle information. When a driving path is planned, map errors caused by observation and positioning and control errors of the movable devices need to be considered. This a safety margin around an obstacle needs to be considered when planning the driving path.

A method of forming the safety margin by related expansion traverses an entire map and directly expands obstacles on the map. When the expansion is directly performed on the map, an expansion operation is needed each time after the map is updated.

### SUMMARY

In accordance with the disclosure, there is provided a map data source processing method. The method includes determining a target pixel for an expansion operation from a map data source, determining an expansion parameter for the expansion operation on the target pixel, and performing the expansion operation on the target pixel based on the expansion parameter.

Also in accordance with the disclosure, there is provided an electronic device. The electronic device includes a memory storing program codes, and a processor configured to invoke and execute the program codes to: determine a target pixel for an expansion operation from a map data source, determine an expansion parameter for the expansion operation on the target pixel, and perform the expansion operation on the target pixel based on the expansion parameter.

### BRIEF DESCRIPTION OF THE DRAWINGS

To more clearly illustrate the technical solution of the present disclosure, the accompanying drawings used in the description of the disclosed embodiments are briefly described hereinafter. The drawings described below are merely some embodiments of the present disclosure. Other drawings may be derived from such drawings by a person with ordinary skill in the art without creative efforts and may be encompassed in the present disclosure.

FIG. 1 is a flow chart of a map source data processing method according to an example embodiment of the present disclosure.

FIG. 2 is a schematic diagram showing target pixel expansion in a map data source according to an example embodiment of the present disclosure.

FIG. 3 and FIG. 4 are schematic diagrams showing an effect on an updated map after the target pixel expansion in the map data source according to an example embodiment of the present disclosure.

FIG. 5 and FIG. 6 are schematic diagrams showing an effect on an updated map after the target pixel expansion in the map data source according to another example embodiment of the present disclosure.

FIG. 7 is a structural block diagram of an electronic device according to an example embodiment of the present disclosure.

### DETAILED DESCRIPTION OF THE EMBODIMENTS

Embodiments of the present disclosure are described in detail below with reference to the accompanying drawings. It will be appreciated that the described embodiments are some rather than all of the embodiments of the present disclosure. Other embodiments obtained by those having ordinary skills in the art on the basis of the described embodiments without inventive efforts should fall within the scope of the present disclosure. In addition, under circumstances of no conflict, the embodiments and the features in the embodiments may be combined with each other.

The terms used in the present disclosure are only for the purpose of describing specific embodiments, rather than limiting the present disclosure. The singular forms of “a,” “said,” and “the” used in the specification and claims of the present disclosure are also intended to include corresponding plural forms unless the context clearly indicates otherwise. It should be understood that the term “and/or” as used herein refers to any or all possible combinations of one or more listed items.

Although the terms “first,” “second,” and “third” are used to describe various information in the present disclosure, the information should not be limited to these terms. These terms are used to distinguish a same type of information from each other. For example, without departing from the scope of the present disclosure, the first information may also be referred to as the second information. Similarly, the second information may also be referred to as the first information. In addition, depending on the context, the term “if” can be interpreted as “when,” “while,” or “in response to.”

The present disclosure provides a map data source processing method. The method includes performing an expansion operation on a target pixel in a map data source before the map data source is used to update a map, such that after the map is updated by the map data source subject to the target pixel expansion operation, a safety margin has already been formed around the target pixel, and there is no need to perform the target pixel expansion operation on the updated map.

The present disclosure also provides a map updating method. The map updating method includes using the map data source subject to the target pixel expansion operation performed by the map data source processing method according to the present disclosure to update a map, such that a safety margin has already been formed around the target pixel in the updated map. Thus, there is no need to perform the target pixel expansion operation on the updated map each time after the map is updated.

Performing the target pixel expansion operation on the map is substantially more complicated than performing the same operation on the map data source. Moreover, repeating the target pixel expansion operation on the entire map each time after the map is partially updated may cause excessive expansion of certain pixels in the map. It is needed to select a portion of the map to perform the target pixel expansion operation. Thus, performing the target pixel expansion operation on the map data source may reduce processing complexity.

An execution entity of the map data source processing method and the map updating method may be an electronic device. In some embodiments, the execution entity may be a same electronic device or different electronic devices. The type of the electronic device is not limited by the present disclosure. The electronic device may be, but is not limited, an imaging device. The electronic device may also be a device connected to an imaging device, which obtains the map source data from the imaging device and performs an operation by the method according to the present disclosure.

When the electronic device is an imaging device, the electronic device may be a movable device having an image acquisition function. For example, the electronic device may be an unmanned automobile, a UAV, or an autonomous robot, which is configured with a camera. Taking the UAV as ab example, during the flight of the UAV, the UAV may obtain the map data source by acquiring images and execute the map data source processing method according to the present disclosure.

The map data source processing method consistent with the present disclosure is described in detail below with various embodiments.

In one embodiment, referring to FIG. 1, the map data source processing method includes the following processes.

At S100, a target pixel for an expansion operation is determined from a map data source.

At S200, an expansion parameter for the expansion operation on the target pixel is determined.

At S300, the expansion operation is performed on the target pixel based on the expansion parameter.

In some embodiments, the method may be executed by an electronic device, or more specifically by a processor of the electronic device. The processor may include one or more processors. The processor may be a general-purpose processor or a special-purpose processor.

The electronic device may be an imaging device or a device connected to an imaging device. For illustration purpose, the electronic device is the imaging device in the following description. The imaging device acquires images. The images acquired by the imaging device may be binocular images. The processor obtains the acquired binocular images. The processor processes the obtained binocular images to obtain a map data source. As such, a pixel feature of pixels in the obtained map data source includes a depth value or a disparity value. The map data source may be obtained other than by processing the binocular images. The map data source may be obtained by processing a plurality of monocular images. The pixel feature of the pixels in the map data source may not necessarily include the depth value or the disparity value, which can be determined according to information required for a particular map update.

At S100, the processor determines the target pixel for the expansion operation from the map data source.

Not all pixels in the map data source need the expansion operation. For example, the expansion operation may be performed on, but is not limited to, the pixels having an abnormal pixel feature or pixels corresponding to a distant object in an actual scene. Thus, the target pixel for the expansion operation needs to be determined from the map data source.

At S100, the map data source may be used to update the map without the expansion operation. The map data source for updating the map and the map data source eventually subject to the expansion operation may be the same or may be two separate map data sources having a same pixel feature.

In some embodiments, after the target pixel is determined from the map data source, the expansion operation may be performed directly on the map data source. In some other embodiments, after the target pixel is determined from the map data source, the map data source duplicated, and a target pixel expansion operation is performed on the duplicated map data source. In some other embodiments, after the target pixel is determined from the map data source, a coordinate of the target pixel is stored. The pixel feature of the target pixel is copied to the pixel feature of a pixel at a corresponding coordinate in a separate map data source including pixels having a blank setting for the pixel feature. The target pixel expansion operation is performed on the separate map data source. The pixel feature of the pixel in the separate map data source subject to the target pixel expansion operation is determined. The determined pixel feature is used to modify the map data source to obtain the map data source after the expansion operation.

At S200, the processor determines the expansion parameter for the expansion operation on the target pixel. Expansion parameters for different target pixels may be the same or different as long as the target pixels are properly expanded. The expansion parameter for the target pixel may be pre-configured or may be calculated, which is not limited by the present disclosure.

In the existing technology, when the expansion operation is performed on the map, a constant expansion radius may be used, resulting in an undesired effect. For example, when the constant expansion radius is used to perform the expansion operation on the pixel of a closer object in a scene and the pixel of a distant object in the scene, the pixel of the closer object may be insufficiently expanded or the pixel of the distant object may be successively expanded. This is caused by not adapting the expansion radius as needed. There may also be other problems.

Consistent with the disclosure, before the target pixel expansion operation is performed, the expansion parameter is determined for the target pixel expansion operation, such that a desired effect can be achieved for each target pixel expansion operation and the above-described problem can be solved.

At S300, the processor performs the expansion operation on the target pixel in the map data source based on the determined expansion parameter. The expansion operation is performed after the target pixel and the corresponding expansion parameter are determined. As described above, the target pixel expansion operation is directly performed on the map data source used for determining the target pixel. The target pixel expansion operation may also be performed on the separate map data source duplicated from the map data source used for determining the target pixel as long as at least useful pixels in the map data source used for determining the target pixel and the separate map data source eventually used for the expansion operation share a same pixel feature.

The useful pixels are normal pixels relative to abnormal pixels and are pixels eventually used for updating the map. For example, an abnormal pixel may include a pixel having a blank setting for the pixel feature and/or a pixel having the pixel feature substantially different from that of adjacent pixels. The substantial pixel feature difference refers to that an absolute value of a difference between the pixel feature of the pixel and the pixel feature of an adjacent pixel exceeds an allowable range.

An execution sequence of S100 through S300 can be as follows. In one example, after determining each target pixel at S100, S200 and then S300 are executed. After S300 is executed, the process continues to execute S100 until the expansion operation is performed on all target pixels. In another example, after some or all target pixels are determined at S100, S200 and then S300 are executed. The present disclosure does not limit how the processes are executed.

In some embodiments, the target pixel is determined from the map data source used for updating the map and the expansion operation is performed on the target pixel. Compared with performing the expansion operation directly on the map, the processing complexity is substantially reduced. An issue of repeating the expansion operation each time after the map is updated is avoided. After the target pixel is determined, the expansion parameter corresponding to the target pixel is determined, such that a suitable expansion parameter is used to perform the expansion operation on each target pixel, thereby achieving the desired expansion effect.

In one embodiment, determining the target pixel for the expansion operation from the map data source at S110 can include traversing all pixels in the map data source and determining whether the pixel feature of each of the traversed pixels satisfies an expansion condition. When the pixel feature of a traversed pixel is determined to satisfy the expansion condition, the traversed pixel is determined as a target pixel for the expansion operation.

The processor can traverse all pixels in the map data source. The traversal process may filter out abnormal pixels and useful pixels that do not need the expansion operation. The expansion condition may include a filtering condition.

In some embodiments, when the pixel feature of the traversed pixel satisfies the expansion condition, the traversed pixel is determined to be the target pixel for the expansion operation. Otherwise, the traversed pixel is skipped. S200 and then S300 may be executed each time after the target pixel is traversed. Then, a subsequent pixel is traversed until all pixels are traversed. In some other embodiments, after all pixels are traversed to obtain all the target pixels, S200 and then S300 are executed as long as information about the target pixel is recorded.

A traversal sequence is not limited by the present disclosure. The traversal sequence may be row by row, column by column, or another suitable sequence as long as at least the useful pixels in the map data source are traversed.

In some embodiments, the expansion condition may be used to select a pixel of a closer object in the scene as the target pixel. In actual applications, more attention is often paid to closer obstacles. Thus, performing the expansion operation only on the pixels of the closer object in the scene may be more cost-effective. If the expansion operation is performed directly on the map, it is needed to traverse all obstacles in the map and then perform the expansion operation on the closer obstacles. The expansion operation is time-consuming. Because the map includes three-dimensional data, a distance between each pixel in the map and the imaging device may be calculated in the traversal process.

In some embodiments, the expansion operation is performed on the map data source. Because the map data source includes two-dimensional data, pixels of the closer object may be quickly identified by traversing and determining whether the expansion condition is satisfied. Compared with performing the expansion directly on the map, the operation complexity and operation time are substantially reduced.

In some embodiments, the pixel feature of the pixel may be the disparity value of the pixel. Determining whether the pixel feature of the traversed pixel satisfies the expansion condition may include: determining whether the disparity value of the traversed pixel is greater than a pre-configured disparity value threshold, determining that the pixel feature of the traversed pixel satisfies the expansion condition if the disparity value of the traversed pixel is greater than the pre-configured disparity value threshold, and determining that the pixel feature of the traversed pixel does not satisfy the expansion condition if the disparity value of the traversed pixel is not greater than the pre-configured disparity value threshold.

The disparity value reflects a distance between the object in the scene and the lens of the imaging device. The shorter the distance, the greater the disparity value. Thus, when the disparity value of the traversed pixel is greater than the pre-configured disparity value threshold, the object corresponding to the traversed pixel is a closer object, the expansion condition is satisfied, and the traversed pixel is determined to be the target pixel. Otherwise, the traversed pixel is skipped.

In some embodiments, the pixel feature of the pixel may be the depth value of the pixel. Determining whether the pixel feature of the traversed pixel satisfies the expansion condition may include: determining whether the depth value of the traversed pixel is smaller than a pre-configured depth value threshold, determining that the pixel feature of the traversed pixel satisfies the expansion condition if the depth value of the traversed pixel is smaller than the pre-configured depth value threshold, and determining that the pixel feature of the traversed pixel does not satisfy the expansion condition if the depth value of the traversed pixel is not smaller than the pre-configured depth value threshold.

The depth value reflects the distance between the object in the scene and the lens of the imaging device. The shorter the distance, the smaller the depth value. Thus, when the depth value of the traversed pixel is smaller than the pre-configured depth value threshold, the object corresponding to the traversed pixel is a closer object, the expansion condition is satisfied, and the traversed pixel is determined to be the target pixel. Otherwise, the traversed pixel is skipped.

The disparity value and the depth value may be converted to each other, so that the above two methods may be used to determine the target pixel regardless of whether the map data source is a disparity map or a depth map. That is, whether the disparity value is greater than the pre-configured disparity value threshold or whether the depth value is smaller than the pre-configured depth value threshold is determined to select the target pixel for the expansion operation, which satisfies the disparity value condition or the depth value condition.

The target pixel having a relatively great disparity value or a relatively small depth value is selected by comparing the pixel feature of the traversed pixel with the pre-configured disparity value threshold or the pre-configured depth value threshold. The expansion operation is targeted on the closer object. The expansion operation is skipped for the distant object. Thus, the expansion operation time is saved while the desired expansion effect is ensured.

In one embodiment, determining the expansion parameter for the target pixel expansion operation at S200 includes obtaining the pixel feature of the target pixel, and determining the expansion parameter for the target pixel expansion operation based on the pixel feature of the target pixel.

Because the target pixel has already been determined as described above, the processor may directly obtain the pixel feature of the target pixel.

The pixel feature of the target pixel may be used to determine the expansion parameter for the target pixel expansion operation.

In one example, if the pixel feature of the pixel is the disparity value, the expansion parameter that can expand the target pixel in a wider range is determined for the target pixel with a greater disparity value, and the expansion parameter that can expand the target pixel in a narrower range is determined for the target pixel with a smaller disparity value. In another example, if the pixel feature of the pixel is the depth value, the expansion parameter that can expand the target pixel in a wider range is determined for the target pixel with a smaller depth value, and the expansion parameter that can expand the target pixel in a narrower range is determined for the target pixel with a greater depth value. As such, the expansion range is determined based on the distance in the scene rather than keeping the constant expansion radius, the expansion is more hierarchical, and the expansion effect is more desirable.

In some embodiments, the expansion parameter is determined based on the pixel feature of each target pixel to achieve the best expansion effect. In some other embodiments, all the target pixels share a same expansion parameter, and the target pixel expansion operation is performed based on a constant expansion radius. In either case, the expansion effect persists after the map is updated and there is no need to perform the expansion operation on the updated map.

In one embodiment, the map data source is the disparity map, and the pixel feature of the target pixel is the disparity value of the target pixel.

The pixel feature of the pixels in the disparity map is the disparity value. The disparity map may be determined by the binocular images acquired by the binocular lenses of the imaging device. A physical distance separating the binocular lenses causes a parallax on the binocular images, and the distance of a target object in the scene may be determined based on the disparity value.

In some embodiments, determining the expansion parameter for the target pixel expansion operation based on the pixel feature of the target pixel includes determining a disparity expansion offset corresponding to the disparity value of the target pixel using an established mapping relationship between the disparity value and the disparity expansion offset, and using the determined disparity expansion offset to determine the expansion parameter for the target pixel expansion operation.

For example, the established mapping relationship between the disparity value and the disparity expansion offset is a table recording each disparity value and the corresponding disparity expansion offset. The disparity expansion offset may be determined by looking up the disparity value in the table. Then, the expansion parameter for the target pixel expansion operation is determined based on the disparity expansion offset.

In some embodiments, the disparity expansion offset may be used to directly determine the expansion parameter. In some other embodiments, a value obtained by performing a calculation on the disparity expansion offset is used to determine the expansion parameter. In one example, when the disparity expansion offset includes a left disparity expansion offset and a right disparity expansion offset, an average of both is calculated to be the expansion parameter. In another example, the left disparity expansion offset and the right disparity expansion offset are used as the expansion parameters for a left target pixel expansion operation and a right target pixel expansion operation, respectively, which have different expansion magnitudes. In another example, the disparity expansion offset includes one disparity expansion offset, which is directly used as the expansion parameter.

In some embodiments, the mapping relationship between the disparity value and the disparity expansion offset may be implemented by another data structure, which is not limited by the present disclosure.

In some embodiments, determining the expansion parameter for the target pixel expansion operation based on the pixel feature of the target pixel includes converting the disparity value of the target pixel to the depth value of the target pixel, determining the depth expansion offset corresponding to the depth value of the target pixel based on the established mapping relationship between the depth value and the depth expansion offset, converting the depth expansion offset to the disparity expansion offset, and determining the expansion parameter for the target pixel expansion operation based on the disparity expansion offset.

The formula for the conversion between the disparity value and the depth value is as follows:

disparity=focus*baseline/depth, (1)

where focus is a focal length of the imaging device, and baseline is a baseline length between the binocular lenses of the imaging device used to acquire the binocular images corresponding to the disparity map.

Formula (1) can be used to convert the disparity value of the target pixel to the depth value of the target pixel. It is shown in formula (1) that the relationship between the disparity value and the depth value is a power function. So it is not linear.

The depth expansion offset corresponding to the depth value of the target pixel can be determined based on the established mapping relationship between the depth value and the depth expansion offset.

For example, the established mapping relationship between the depth value and the depth expansion offset is a table recording each depth value and the corresponding depth expansion offset. The depth expansion offset may be determined by looking up the depth value in the table.

Specifically, after the depth value depth corresponding to the disparity value and the depth expansion offsets plus and sub corresponding to the depth value are determined, expansion depth values depth_plus and depth_sub can be determined by formula (2):

depth_plus=depth+plus,depth_sub=depth−sub. (2)

Formula (1) can also be used to convert the depth expansion offset to the disparity expansion offset, and the expansion parameter for the target pixel expansion operation can be determined based on the disparity expansion offset.

The expansion depth value depth_plus is inputted into formula (1) to obtain the corresponding expansion disparity value disparity_sub. The expansion depth value depth_sub is inputted into formula (1) to obtain the corresponding expansion disparity value disparity_plus. Thus, the disparity expansion offsets dis_sub and dis_plus can be calculated by formula (3) and formula (4) as follows:

disparity_sub=focus*baseline/depth_plus=disparity+dis_sub, (3)

disparity_plus=focus*baseline/depth_sub=disparity+dis_plus. (4)

Further, determining the expansion parameter for the target pixel expansion operation based on the disparity expansion offset can include determining an expansion radius based on the disparity expansion offset, and determining the expansion parameter for the target pixel expansion operation based on the expansion radius.

Specifically, after the calculations based on formula (3) and formula (4) are completed, the expansion radius radius is determined based on the disparity expansion offsets dis_sub and dis_plus using formula (5) as follows:

radius=(dis_sub+dis_plus)/2. (5)

In some embodiments, the average of the disparity expansion offsets dis_sub and dis_plus is determined to be the expansion radius. In some other embodiments, a weighted aggregation of the disparity expansion offsets dis_sub and dis_plus is determined to be the expansion radius. In some other embodiments, one of the disparity expansion offsets dis_sub and dis_plus is determined to be the expansion radius. The present disclosure does not limit the way to calculate the expansion radius. As such, different disparity values are used to obtain the corresponding expansion radius, and the expansion radius id determined to be the expansion parameter for the target pixel expansion operation.

Because the expansion of the map data source eventually needs to be presented in the map, it is determined based on an amount of expansion needed in the map. The amount of expansion needed in the map is directly measured by the depth expansion offset of the depth value but is difficult to be measured directly by the disparity value. Thus, the disparity value is converted to the depth value to determine the depth expansion offset, and then the expansion parameter corresponding to the disparity value is determined based on the depth expansion offset. As a result, the expansion effect more likely meets the expectation.

In one embodiment, the map data source is the depth map, and the pixel feature of the target pixel is the depth value of the target pixel.

The pixel feature of each pixel in the depth map is the depth value. The depth map may be determined by the binocular images acquired by the binocular lenses of the imaging device. The distance of a target object in the scene may be determined based on the depth value.

In some embodiments, determining the expansion parameter for the target pixel expansion operation based on the pixel feature of the target pixel can include determining the depth expansion offset corresponding to the depth value of the target pixel based on an established mapping relationship between the depth value and the depth expansion offset, and determining the expansion parameter for the target pixel expansion operation based on the depth expansion offset.

For example, the established mapping relationship between the depth value and the depth expansion offset is a table recording each depth value and the corresponding depth expansion offset. The depth expansion offset may be determined by looking up the depth value in the table. Then, the expansion parameter for the target pixel expansion operation is determined based on the depth expansion offset.

In some embodiments, the mapping relationship between the depth value and the depth expansion offset may be in implemented by another data structure, and is not limited to the form of a table.

Further, determining the expansion parameter for the target pixel expansion operation based on the depth expansion offset can include determining the expansion radius based on the depth expansion offset and determining the expansion parameter for the target pixel expansion operation based on the expansion radius. For example, the depth expansion offset may be directly used as the expansion radius, and the expansion parameter for the target pixel expansion operation is determined based on the expansion radius.

In one embodiment, performing the target pixel expansion operation on the map data source based on the expansion parameter at S300 includes performing the expansion operation on the target pixel in the map data source with the target pixel as a center toward a left direction and a right direction of the target pixel based on the expansion parameter.

The left direction and the right direction in the map data source are horizontal directions, which are consistent with the left direction and the right direction of the binocular lenses used to acquire the corresponding images of the nap data source. Because the two binocular lenses are arranged in a left-right relationship, there will only be parallax in the horizontal directions. Thus, it is only needed to expand the target pixel in the map data source with the target pixel as the center toward the left and the right in a range according to the expansion parameter.

In one embodiment, the expansion parameter is the expansion radius. Performing the expansion operation on the target pixel in the map data source with the target pixel as the center toward the left direction and the right direction of the target pixel based on the expansion parameter can include determining a target region of the expansion radius with the target pixel as the center in the left direction and the right direction of the target pixel, and performing the expansion operation on the target pixel according to the target region.

The target region is determined with the target pixel as the center according to the expansion parameter. The expansion parameter can be the expansion radius and the target region is determined in the left direction and the right direction of the target pixel with the target pixel as the center. A first region is determined by extending from the target pixel to the left direction of the target pixel by a length equal to the expansion radius. A second region is determined by extending from the target pixel to the right direction of the target pixel by a length equal to the expansion radius. The first region, the target pixel, and the second region together form the target region.

The expansion operation is performed on the target pixel according to the target region. Because there can be many target pixels in the map data source, the target regions may overlap. The expansion operation may be performed on the target pixel depending on whether the adjacent target regions overlap with each other. In some embodiments, the expansion operation is directly performed on the target pixel within the target region.

In some embodiments, performing the expansion operation on the target pixel within the target region includes, when there is no expanded pixel in the target region, modifying the pixel feature of various pixels in the target region to be the pixel feature of the target pixel, and when there is at least one expanded pixel in the target region, modifying the pixel feature of unexpanded pixels in the target region to be the pixel feature of the target pixel and determining a pixel feature of the at least one expanded pixel in the target region based on both the pixel feature of the at least one expanded pixel and the pixel feature of the target pixel.

When there is no expanded pixel in the target region, the expansion operation is directly performed on the target pixel. When there is at least one expanded pixel in the target region, the target region of the target pixel may overlap with another target region. The pixel feature of unexpanded pixels in the target region is modified to be the pixel feature of the target pixel and the pixel feature of the at least one expanded pixel in the target region is determined based on both the pixel feature of the at least one expanded pixel and the pixel feature of the target pixel. As such, a better expansion effect can be achieved.

In some embodiments, referring to FIG. 2, pixel 2 and pixel 5 are target pixels. The target region of pixel 2 includes pixels 0-4. The target region of pixel 5 includes pixels 2-8. When the expansion operation is performed on pixel 2, because there is no expanded pixel in pixels 0-4, the pixel feature of pixels 0-4 is modified to be the pixel feature of pixel 2. When the expansion operation is performed on pixel 5, pixels 5-8 are unexpanded pixels. The pixel feature of pixels 5-8 is modified to be the pixel feature of the target pixel (i.e., pixel 5). Pixels 2-4 are expanded pixels and hence a pixel feature selected from the pixel feature of pixels 2-4 (the expanded pixels) and the pixel feature of pixel 5 to be the pixel feature of pixels 2-4. One of the pixel feature of expanded pixels 2-4 and the pixel feature of target pixel 5 that indicates a closer distance to the imaging device will be selected as the final pixel feature of pixels 2-4.

In some embodiments, the pixel feature is the disparity value. Correspondingly, the map data source is the disparity map. Determining the pixel feature of the expanded pixels based on the pixel feature of the expanded pixels and the pixel feature of the target pixel includes the following processes. A difference between the disparity value of the expanded pixels and the disparity value of the target pixel is calculated. If the disparity value of the expanded pixels is greater than or equal to the disparity value of the target pixel, the disparity value of the expanded pixels remains unchanged. If the disparity value of the expanded pixels is smaller than the disparity value of the target pixel, the disparity value of the expanded pixels is modified to the disparity value of the target pixel.

In some embodiments, referring to FIG. 2, pixels 2-4 are expanded pixels. The larger one of the disparity value of the expanded pixels and the disparity value of target pixel 5 is selected as the final disparity value of the expanded pixels, such that the closer object has the higher priority for the expansion operation.

In some embodiments, the pixel feature is the depth value. Correspondingly, the map data source us the depth map. Determining the pixel feature of the expanded pixels based on the pixel feature of the expanded pixels and the pixel feature of the target pixel includes the following processes. A difference between the depth value of the expanded pixels and the depth value of the target pixel is calculated. If the depth value of the expanded pixels is smaller than or equal to the depth value of the target pixel, the depth value of the expanded pixels remains unchanged. If the depth value of the expanded pixels is greater than the depth value of the target pixel, the depth value of the expanded pixels is modified to the depth value of the target pixel.

In some embodiments, referring to FIG. 2, pixels 2-4 are expanded pixels. The smaller one of the depth value of the expanded pixels and the depth value of target pixel 5 is selected as the final depth value of the expanded pixels, such that the closer object has the higher priority for the expansion operation.

FIG. 3 is a schematic diagram showing a map updated by an unexpanded map data source according to an example embodiment of the present disclosure. FIG. 4 is a schematic diagram showing a map updated by an expanded map data source according to an example embodiment of the present disclosure. The human body inside the dotted line frame is a closer object. Comparing FIG. 3 and FIG. 4, the human body inside the dotted line frame is expanded in FIG. 4 while another object outside the dotted line frame is a distant object and is not expanded in FIG. 4.

FIG. 5 is a three-dimensional (3D) diagram showing a map updated by an unexpanded map data source according to an example embodiment of the present disclosure. FIG. 6 is a 3D diagram showing a map updated by an expanded map data source according to an example embodiment of the present disclosure. The human body inside the solid line frame is a closer object. Comparing FIG. 5 and FIG. 6, the human body inside the solid line frame is expanded in FIG. 6 while other objects outside the solid line frame are distant objects and are not expanded in FIG. 6.

The present disclosure also provides an electronic device that executes a map data source processing method consistent with the disclosure, such as one of the above-described example methods. FIG. 7 is a structural block diagram of an electronic device 100 according to an example embodiment of the present disclosure. Referring to FIG. 7, the electronic device 100 includes a memory 101 and a processor 102 (e.g., one or more processors). The type of the electronic device is not limited by the present disclosure. The electronic device may be, but is not limited to, an imaging device. The electronic device may be a device connected to the image device, which obtains the map data source from the imaging device and executes the corresponding method consistent with the present disclosure.

In some embodiments, the memory 101 is configured to store program codes and the processor 102 is configured to invoke and execute the program codes. When being executed by the processor 102, the program codes perform: determining a target pixel from a map data source for an expansion operation, determining an expansion parameter for the expansion operation on the target pixel, and performing the expansion operation on the target pixel based on the expansion parameter.

In some embodiments, when determining the target pixel from the map data source for the expansion operation, the processor 102 is configured to perform: traversing pixels in the map data source, determining whether a pixel feature of a traversed pixel satisfies a pre-configured expansion condition, and determining the traversed pixel to be the target pixel for the expansion operation when the pixel feature of the traversed pixel satisfies the pre-configured expansion condition.

In some embodiments, the pixel feature of each pixel is a disparity value of the pixel. Determining whether the pixel feature of the traversed pixel satisfies the pre-configured expansion condition includes: determining whether the disparity value of the traversed pixel is greater than a pre-configured disparity value threshold, determining that the pixel feature of the traversed pixel satisfies the pre-configured expansion condition when the disparity value of the traversed pixel is greater than the pre-configured disparity value threshold, and determining that the pixel feature of the traversed pixel does not satisfy the pre-configured expansion condition when the disparity value of the traversed pixel is not greater than the pre-configured disparity value threshold.

In some embodiments, the pixel feature of each pixel is a depth value of the pixel. Determining whether the pixel feature of the traversed pixel satisfies the pre-configured expansion condition includes: determining whether the depth value of the traversed pixel is greater than a pre-configured depth value threshold, determining that the pixel feature of the traversed pixel satisfies the pre-configured expansion condition when the depth value of the traversed pixel is smaller than the pre-configured depth value threshold, and determining that the pixel feature of the traversed pixel does not satisfy the pre-configured expansion condition when the depth value of the traversed pixel is not smaller than the pre-configured depth value threshold.

In some embodiments, when determining the expansion parameter for the expansion operation on the target pixel, the processor 102 is configured to: obtain the pixel feature of the target pixel, and determine the expansion parameter for the expansion operation on the target pixel based on the pixel feature of the target pixel.

In some embodiments, the map data source is a disparity map. Correspondingly, the pixel feature of the target pixel is the disparity value of the target pixel.

In some embodiments, when determining the expansion parameter for the expansion operation on the target pixel based on the pixel feature of the target pixel, the processor 102 is configured to: determine a disparity expansion offset corresponding to the disparity value of the target pixel using an established mapping relationship between the disparity value and the disparity expansion offset, and determine the expansion parameter for the expansion operation on the target pixel based on the determined disparity expansion offset.

In some embodiments, when determining the expansion parameter for the expansion operation on the target pixel based on the pixel feature of the target pixel, the processor 102 is configured to: convert the disparity value of the target pixel to the depth value of the target pixel, determine a depth expansion offset corresponding to the depth value of the target pixel using an established mapping relationship between the depth value and the depth expansion offset, convert the depth expansion offset to the disparity expansion offset, and determine the expansion parameter for the expansion operation on the target pixel based on the determined disparity expansion offset.

In some embodiments, when determining the expansion parameter for the expansion operation on the target pixel based on the disparity expansion offset, the processor 102 is configured to: determine an expansion radius based on the disparity expansion offset, and determine the expansion radius to be the expansion parameter for the expansion operation on the target pixel.

In some embodiments, the map data source is a depth map. Correspondingly, the pixel feature of the target pixel is the depth value of the target pixel.

In some embodiments, when determining the expansion parameter for the expansion operation on the target pixel based on the pixel feature of the target pixel, the processor 102 is configured to: determine the depth expansion offset corresponding to the depth value of the target pixel using an established mapping relationship between the depth value and the depth expansion offset, and determine the expansion parameter for the expansion operation on the target pixel based on the determined depth expansion offset.

In some embodiments, when determining the expansion parameter for the expansion operation on the target pixel based on the depth expansion offset, the processor 102 is configured to: determine the expansion radius based on the depth expansion offset, and determine the expansion radius to be the expansion parameter for the expansion operation on the target pixel.

In some embodiments, when performing the expansion operation on the target pixel in the map data source based on the expansion parameter, the processor 102 is configured to: perform the expansion operation on the target pixel in the map data source with the target pixel as a center toward a left direction and a right direction of the target pixel based on the expansion parameter.

In some embodiments, the expansion parameter is the expansion radius. When performing the expansion operation on the target pixel in the map data source with the target pixel as the center toward the left direction and the right direction of the target pixel based on the expansion parameter, the processor 102 is configured to: determine a target region of the expansion radius with the target pixel as the center in the left direction and the right direction of the target pixel, and perform the expansion operation on the target pixel within the target region.

In some embodiments, when performing the expansion operation on the target pixel within the target region, the processor 102 is configured to: when there is no expanded pixel in the target region, modify the pixel feature of pixels in the target region to be the pixel feature of the target pixel; and when there is at least one expanded pixel in the target region, modify the pixel feature of unexpanded pixels in the target region to be the pixel feature of the target pixel and determine the pixel feature of the at least one expanded pixel in the target region based on both the pixel feature of the at least one expanded pixel and the pixel feature of the target pixel.

In some embodiments, the pixel feature is the disparity value. When determining the pixel feature of the at least one expanded pixel based on both the pixel feature of the at least one expanded pixel and the pixel feature of the target pixel, the processor 102 is configured to: calculate a difference between the disparity value of the expanded pixels and the disparity value of the target pixel, keep the disparity value of the expanded pixels unchanged if the disparity value of the expanded pixels is greater than or equal to the disparity value of the target pixel, and modify the disparity value of the expanded pixels to the disparity value of the target pixel if the disparity value of the expanded pixels is smaller than the disparity value of the target pixel.

In some embodiments, the pixel feature is the depth value. When determining the pixel feature of the at least one expanded pixel based on both the pixel feature of the at least one expanded pixel and the pixel feature of the target pixel, the processor 102 is configured to: calculate a difference between the depth value of the expanded pixels and the depth value of the target pixel, keep the depth value of the expanded pixels unchanged if the depth value of the expanded pixels is smaller than or equal to the depth value of the target pixel, and modify the depth value of the expanded pixels to the depth value of the target pixel if the depth value of the expanded pixels is greater than the depth value of the target pixel.

The present disclosure also provides a computer-readable storage medium that stores computer instructions. The type of the computer-readable storage medium is not limited in the present disclosure. When being executed, the computer instructions implement a map data source processing method consistent with the disclosure, such as one of the above-described example methods.

The present disclosure also provides a map updating method. The method includes a map data source processing method consistent with the disclosure, such as one of the above-described example methods and using the map data source after the expansion operation on the target pixel to update the map that has already been generated.

The present disclosure also provides an electronic device that executes a map updating method consistent with the disclosure, such as one of the above-described example methods. The electronic device includes a memory and a processor (e.g., one or more processors). The type of the electronic device is not limited in the present disclosure. The electronic device may be, but is not limited to, an imaging device. The electronic device may be a device connected to the image device, which obtains the map data source from the imaging device and executes the corresponding method consistent with the present disclosure. The electronic device may be the electronic device shown in FIG. 7.

In some embodiments, the memory is configured to store program codes and the processor is configured to invoke and execute the program codes. When the program codes are executed by the processor, the processor is configured to implement the above-described map updating method.

The present disclosure also provides another computer-readable storage medium that stores computer instructions. The type of the computer-readable storage medium is not limited in the present disclosure. When being executed, the computer instructions implement a map updating method consistent with the present disclosure, such as one of the above-described example methods.

The systems, devices, modules, or units described in the embodiments of the present disclosure may be realized by computer chips or physical entities or by products with certain functions. A typical implementation device is a computer. The specific form of the computer may include at least one of a personal computer, a laptop computer, a cellular phone, a camera phone, a smart phone, a personal digital assistant, a media player, a navigation device, an email receiving and sending device, and a game control console, a tablet computer, or a wearable device.

For the convenience of description, when describing the above devices, the functions are divided into various units and described separately. In the embodiments of the present disclosure, the functions of the individual units may be implemented by a same or more software and/or hardware.

Those skilled in the art should understand that the embodiments o the present disclosure may be provided as method, systems, or computer program products. Thus, the present disclosure may take a form of a complete hardware implementation, a complete software implementation, or an implementation combining hardware and software. Moreover, the present disclosure may take a form of computer program product implemented at one or more computer-readable storage media (including but not limited to a magnetic disk, a CD-ROM, an optical disk, etc.) containing computer-readable program codes.

The embodiments of the present disclosure are described with reference to flow charts and/or structural block diagrams of methods, devices (systems), and computer program products consistent with the embodiments of the present disclosure. It should be understood that each process and/or each structural block in the flow charts and/or the structural diagrams and various combination of each process and/or each structural block in the flow charts and/or the structural diagrams may be implemented by computer program instructions. The computer program instructions may be provided to a general-purpose computer, a special-purpose computer, an embedded processor, or a processor or another programmable data processing device to produce a machine, such that when being executed by the computer or the processor of another programmable data processing device, the computer program instructions produce the devices that implement the functions specified in one or more processes in the flow charts and/or one or more structural blocks in the structural diagrams.

Moreover, the computer program instructions may also be stored in a computer-readable memory that guides the computer or the processor of another programmable data processing device to operate in a specific manner, such that when being executed, the computer program instructions stored in the computer-readable memory produce an article of manufacture containing an instruction device. The instruction device implements the functions specified in one or more processes in the flow charts and/or one or more structural blocks in the block diagrams.

The computer program instructions may also be loaded to the computer or the processor of another programmable data processing device, such that a series of operation processes are executed by the computer or the processor of another programmable data processing device to produce computer-implemented process. Thus, when being executed by the computer or the processor of another programmable data processing device, the computer program instructions implements the functions specified in one or more processes in the flow charts and/or one or more structural blocks in the block diagrams.

In the specification, specific examples are used to explain the principles and implementations of the present disclosure. The description of the embodiments is intended to assist comprehension of the methods and core inventive ideas of the present disclosure. At the same time, those of ordinary skill in the art may change or modify the specific implementation and the scope of the application according to the embodiments of the present disclosure. Thus, the content of the specification should not be construed as limiting the present disclosure.

What is claimed is:

1. A map data source processing method comprising:
determining a target pixel for an expansion operation from a map data source;
determining an expansion parameter for the expansion operation on the target pixel; and
performing the expansion operation on the target pixel based on the expansion parameter.

2. The method according to claim 1, wherein determining the target pixel for the expansion operation from the map data source includes:
traversing pixels in the map data source;
determining whether a pixel feature of a traversed pixel satisfies a pre-configured expansion condition; and
determining the traversed pixel to be the target pixel in response to the pixel feature of the traversed pixel satisfying the pre-configured expansion condition.

3. The method according to claim 2, wherein:
the pixel feature includes a disparity value; and
determining whether the pixel feature of the traversed pixel satisfies the pre-configured expansion condition includes:
determining whether the disparity value of the traversed pixel is greater than a pre-configured disparity value threshold;
determining that the pixel feature of the traversed pixel satisfies the pre-configured expansion condition in response to the disparity value of the traversed pixel being greater than the pre-configured disparity value threshold; and
determining that the pixel feature of the traversed pixel does not satisfy the pre-configured expansion condition in response to the disparity value of the traversed pixel being not greater than the pre-configured disparity value threshold.

4. The method according to claim 2, wherein:
the pixel feature includes a depth value; and
determining whether the pixel feature of the traversed pixel satisfies the pre-configured expansion condition includes:
determining whether the depth value of the traversed pixel is smaller than a pre-configured depth value threshold;
determining that the pixel feature of the traversed pixel satisfies the pre-configured expansion condition in response to the depth value of the traversed pixel being smaller than the pre-configured depth value threshold; and
determining that the pixel feature of the traversed pixel does not satisfy the pre-configured expansion condition in response to the depth value of the traversed pixel being not smaller than the pre-configured depth value threshold.

5. The method according to claim 1, wherein determining the expansion parameter for the expansion operation on the target pixel includes:
obtaining a pixel feature of the target pixel; and
determining the expansion parameter for the expansion operation on the target pixel based on the pixel feature of the target pixel.

6. The method according to claim 5, wherein:
the map data source includes a disparity map; and
the pixel feature of the target pixel includes a disparity value of the target pixel.

7. The method according to claim 6, wherein determining the expansion parameter for the expansion operation on the target pixel based on the pixel feature of the target pixel includes:
determining a disparity expansion offset corresponding to the disparity value of the target pixel using an established mapping relationship between the disparity value and the disparity expansion offset; and
determining the expansion parameter for the expansion operation on the target pixel based on the determined disparity expansion offset.

8. The method according to claim 6, wherein determining the expansion parameter for the expansion operation on the target pixel based on the pixel feature of the target pixel includes:
converting the disparity value of the target pixel to a depth value of the target pixel;
determining a depth expansion offset corresponding to the depth value of the target pixel using an established mapping relationship between the depth value and the depth expansion offset;
converting the depth expansion offset to a disparity expansion offset; and
determining the expansion parameter for the expansion operation on the target pixel based on the disparity expansion offset.

9. The method according to claim 7, wherein determining the expansion parameter for the expansion operation on the target pixel based on the disparity expansion offset includes:
determining an expansion radius based on the disparity expansion offset; and
determining the expansion radius to be the expansion parameter for the expansion operation on the target pixel.

10. The method according to claim 5, wherein:
the map data source includes a depth map; and
the pixel feature of the target pixel includes a depth value of the target pixel.

11. The method according to claim 10, wherein determining the expansion parameter for the expansion operation on the target pixel based on the pixel feature of the target pixel includes:
determining a depth expansion offset corresponding to the depth value of the target pixel using an established mapping relationship between the depth value and the depth expansion offset; and
determining the expansion parameter for the expansion operation on the target pixel based on the depth expansion offset.

12. The method according to claim 11, wherein determining the expansion parameter for the expansion operation on the target pixel based on the depth expansion offset includes:
determining an expansion radius based on the depth expansion offset; and
determining the expansion radius to be the expansion parameter for the expansion operation on the target pixel.

13. The method according to claim 1, wherein performing the expansion operation on the target pixel in the map data source based on the expansion parameter includes:
performing the expansion operation on the target pixel in the map data source with the target pixel as a center toward a left direction and a right direction of the target pixel based on the expansion parameter.

14. The method according to claim 13, wherein:
the expansion parameter includes an expansion radius; and
performing the expansion operation on the target pixel in the map data source with the target pixel as the center toward the left direction and the right direction of the target pixel based on the expansion parameter includes:
determining a target region with the target pixel as the center and having the expansion radius in the left direction and the right direction of the target pixel; and
performing the expansion operation on the target pixel according to the target region.

15. The method according to claim 14, wherein performing the expansion operation on the target pixel according to the target region includes:
in response to determining there is no expanded pixel in the target region, modifying the pixel feature of another pixel in the target region to be the pixel feature of the target pixel; and
in response to determining there is an expanded pixel in the target region:
modifying the pixel feature of an unexpanded pixel in the target region to be the pixel feature of the target pixel; and
determining a final value of the pixel feature of the expanded pixel based on a current value of the pixel feature of the expanded pixel and the pixel feature of the target pixel.

16. The method according to claim 15, wherein:
the pixel feature includes a disparity value; and
determining the final value of the pixel feature of the expanded pixel based on the current value of the pixel feature of the expanded pixel and the pixel feature of the target pixel includes:
calculating a difference between a current value of the disparity value of the expanded pixel and the disparity value of the target pixel;
determining the current value of the disparity value of the expanded pixel as a final value of the disparity value of the expanded pixel in response to the current value of the disparity value of the expanded pixel being greater than or equal to the disparity value of the target pixel; and
determining the disparity value of the target pixel as the final value of the disparity value of the expanded pixel in response to the current value of the disparity value of the expanded pixel being smaller than the disparity value of the target pixel.

17. The method according to claim 15, wherein:
the pixel feature includes a depth value; and
determining the final value of the pixel feature of the expanded pixel based on the current value of the pixel feature of the expanded pixel and the pixel feature of the target pixel includes:
calculating a difference between a current value of the depth value of the expanded pixel and the depth value of the target pixel;
determining the current value of the depth value of the expanded pixels as a final value of the depth value of the expanded pixel in response to the current value of the depth value of the expanded pixel being smaller than or equal to the depth value of the target pixel; and
determining the depth value of the target pixel as the final value of the depth value of the expanded pixel in response to the current value of the depth value of the expanded pixel being greater than the depth value of the target pixel.

18. An electronic device comprising:
a memory storing program codes; and
a processor configured to invoke and execute the program codes to:
determine a target pixel for an expansion operation from a map data source;
determine an expansion parameter for the expansion operation on the target pixel; and
perform the expansion operation on the target pixel based on the expansion parameter.

19. The electronic device according to claim 18, wherein the electronic device is an unmanned aerial vehicle (UAV) connected to an imaging device, the map data source is obtained by processing images acquired by the imaging device.

20. The electronic device according to claim 19, wherein the imaging device includes a binocular image device.
